(19) United States
(12) Patent Application Publication
(10) Pub. No.: US 2017/0073254 A1
(43) Pub. Date: Mar. 16, 2017

(54) SYSTEMS AND METHODS FOR REMOVING FINELY DISPERSED PARTICULATE MATTER FROM A FLUID STREAM

(71) Applicant: Soane Mining, LLC, Cambridge, MA (US)

(72) Inventors: David S. Soane, Palm Beach, FL (US); J. Nathan Ashcraft, Jupiter, FL (US); Phyo Nyi Nyi Kyaw, (US)

(73) Assignee: Soane Mining, LLC, Cambridge, MA (US)

(21) Appl. No.: 15/272,853

(22) Filed: Sep. 22, 2016

Related U.S. Application Data
(63) Continuation of application No. 13/190,973, filed on Jul. 26, 2011.
(60) Provisional application No. 61/368,026, filed on Jul. 27, 2010.

(51) Int. Cl. C02F 1/52; C02F 1/38; C02F 1/00; C01D 3/14

(52) U.S. Cl. CPC C02F 1/52; C02F 1/5272; C02F 1/5236; C01D 3/14; C02F 1/385; C02F 1/001; C02F 2101/10

(57) ABSTRACT

The invention includes methods of removing particulate matter from potash tailings fluid comprising providing an activating material capable of being affixed to the particulate matter, affixing the activating material to the particulate matter to form an activated particle, providing an anchor particle and a tethering material capable of being affixed to the anchor particle; and attaching the tethering material to the anchor particle and the activated particle to form a removable complex in the potash tailings fluid. The invention also includes providing an activating material capable of being affixed to the particulate matter in the potash tailings fluid; affixing the activating material to the particulate matter to form an activated particle; providing an anchor particle and enveloping it with an enveloping agent to form an enveloped anchor particle capable of attaching to the activated particle; and combining the enveloped anchor particle with the activated particle to form a removable complex.

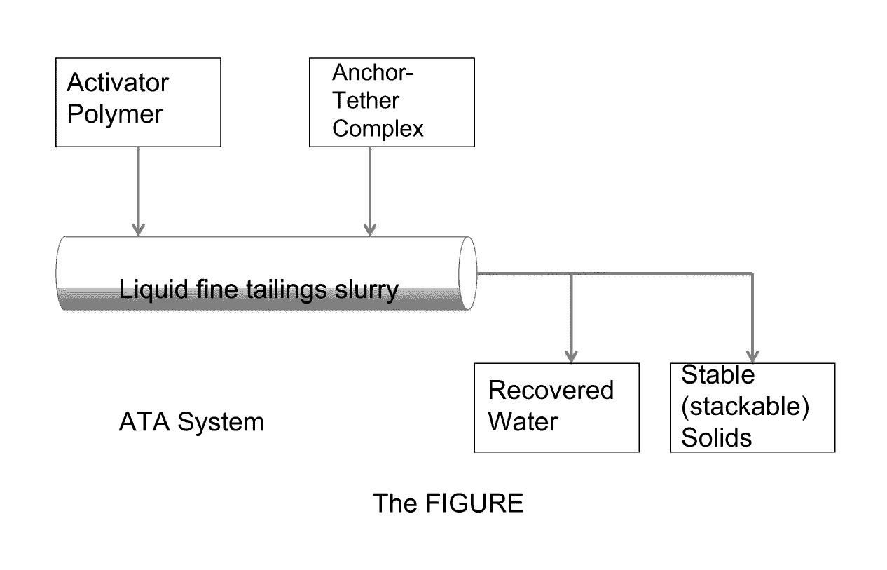

### RELATED APPLICATIONS

This application is a continuation of U.S. application Ser. No. 13/190,973, filed Jul. 26, 2011, which claims the benefit of U.S. Provisional Application Ser. No. 61/368,026 filed Jul. 27, 2010. The entire teachings of the above applications are incorporated herein by reference.

### PARTIES TO A JOINT RESEARCH AGREEMENT

Soane Mining, LLC and Soane Energy, LLC are parties to a “joint research agreement” as defined in 35 U.S.C. 103(c)(3).

### FIELD OF THE APPLICATION

The application relates generally to the use of particles for removing finely dispersed particulate matter from fluid streams.

### BACKGROUND

Fine materials generated from mining activities are often found well-dispersed in aqueous environments, such as wastewater. The finely dispersed materials may include such solids as various types of clay materials, recoverable materials, fine sand and silt. Separating these materials from the aqueous environment can be difficult, as they tend to retain significant amounts of water, even when separated out, unless special energy-intensive dewatering processes or long-term settling practices are employed.

An example of a high volume water consumption process is the processing of naturally occurring ores. During the processing of such ores, colloidal particles, such as clay and mineral fines, are released into the aqueous phase often due to the introduction of mechanical shear associated with the hydrocarbon-extraction process. In addition to mechanical shear, alkali water is sometimes added during extraction, creating an environment more suitable for colloidal suspensions. A common method for disposal of the resulting “tailing” solutions, which contain fine colloidal suspensions of clay and minerals, water, sodium hydroxide and small amounts of remaining hydrocarbon, is to store them in “tailings ponds.” These ponds take years to settle out the contaminating fines, posing severe environmental challenges. It is desirable to identify a method for treating tailings from mining operations to reduce the existing tailings ponds, and/or to prevent their further expansion.

Certain mining processes use a large volume of water, placing strains on the local water supply. It would be advantageous, therefore, to reuse the water from tailings streams, so that there is less need for fresh water in the beneficiation process. In addition, certain mining processes can create waste streams of large-particle inorganic solids. This residue is typically removed in initial separation phases of processing due to its size, insolubility and ease of sequestering. Disposal or storage of this waste material represents a problem for the mining industry. It would be advantageous to modify this material so that it could be useful in-situ, for example as part of a treatment for the mining wastewater.

Potash, originally known as wood ash, refers to a collection of potassium salts and other potassium compounds, the most abundant being potassium chloride. Potash accounts for the majority of potassium produced in the world. Approximately 95% of potash produced is used for fertilizers, and the rest in manufacturing soaps, glass, ceramics, chemical dyes, etc. Mining for potash mainly consists of extraction from buried evaporates using underground or solution mining. The tailings streams produced from potash mining are usually slurry mixtures of clay in combination with high levels of sodium chloride and other salts. When released into the environment untreated, the suspensions in these tailings take a long time to settle, creating tailings ponds that can take up to 40-70% of the mine area. During settling time, the mechanical integrity of the sedimentation is low due to high water content and the area is not fit to be used for any purpose.

A typical approach to consolidating fine materials dispersed in water involves the use of coagulants or flocculants. This technology works by linking together the dispersed particles by use of multivalent metal salts (such as calcium salts, aluminum compounds or the like) or high molecular weight polymers such as partially hydrolyzed polyacrylamides. With the use of these agents, there is an overall size increase in the suspended particle mass; moreover, their surface charges are neutralized, so that the particles are destabilized. The overall result is an accelerated sedimentation of the treated particles. Following the treatment, though, a significant amount of water remains trapped with the sedimented particles. These technologies typically do not release enough water from the sedimented material that the material becomes mechanically stable. In addition, the substances used for flocculation/coagulation may not be cost-effective, especially when large volumes of wastewater require treatment, in that they require large volumes of flocculant and/or coagulant. While ballasted flocculation systems have also been described, these systems are inefficient in sufficiently removing many types of fine particles, such as those fine particles that are produced in wastewater from mining processes.

There remains an overall need in the art, therefore, for a treatment system that removes suspended particles from a fluid solution quickly, cheaply, and with high efficacy. It is also desirable that the treatment system yields a recovered (or recoverable) solid material that retains minimal water, so that it can be readily processed into a substance that is mechanically stable. It is further desirable that the treatment system facilitates the reuse of process fluid for mining operations. For example, in potash processing, the salt-brine solution in tailings can be reused in mining operations.

An additional need in the art pertains to the management of existing tailings ponds. In their present form, they are environmental liabilities that may require extensive clean-up efforts in the future. It is desirable to prevent their expansion. It is further desirable to improve their existing state, so that their contents settle more efficiently and completely. A more thorough and rapid separation of solid material from liquid solution in the tailings pond could allow retrieval of recyclable water and compactable waste material, with an overall reduction of the footprint that they occupy.

For potash, it is desirable to treat the tailings in order to facilitate sedimentation of clay and salt suspensions and increase water recovery. However, the high salt (for example, sodium chloride) content of these tailings proves hostile to most conventional flocculants (e.g., anionic polyacrylamides). It has been observed that the salinity of potash tailings is high enough to cause precipitation and other adverse effects to such flocculants. There remains a need in the art, therefore, for technologies specifically addressing the problems associated with potash tailings treatment.

### SUMMARY

Disclosed herein, in embodiments, are methods of removing particulate matter from potash tailings fluid, comprising providing an activating material capable of being affixed to the particulate matter, affixing the activating material to the particulate matter to form an activated particle, providing an anchor particle and providing a tethering material capable of being affixed to the anchor particle; and attaching the tethering material to the anchor particle and the activated particle to form a removable complex in the potash tailings fluid, wherein the removable complex comprises the particulate matter. In embodiments, these methods can further comprise removing the removable complex from the potash tailings fluid. The removable complex can be removed by filtration, centrifugation, gravity drainage, or any other removal method familiar to those of ordinary skill in the art. In embodiments, the anchor particle is enveloped by an enveloping agent. In embodiments, the enveloping agent is selected from the group consisting of waxes, hydrocarbons and hydrocarbon blends. In embodiments, the anchor particle can comprise sand. In other embodiments, the anchor particle can comprise salt particles, for example, sodium chloride, magnesium sulfate (MgSO₄), magnesium chloride (MgCl₂), or calcium sulfate (CaSO₄) particles. In certain embodiments, the anchor particle comprises sodium chloride. In embodiments, the anchor particle can comprise a material that is indigenous to the mining operation. In embodiments, the particulate matter can comprise clay fines. The methods can include additional steps, for example, chemically modifying the potash tailings fluid, before, during or after the steps previously disclosed. In embodiments, the potash tailings fluid comprises waste tailings fluid from a mining operation, or comprises potash tailings fluid from impounded tailings in a tailings pond or other containment area. Disclosed herein are also products that are obtained by the performance of these methods.

Disclosed herein, in embodiments, are methods for removing particulate matter from potash tailings fluid, comprising providing an activating material capable of being affixed to the particulate matter in the potash tailings fluid; affixing the activating material to the particulate matter to form an activated particle; providing an anchor particle and enveloping it with an enveloping agent to form an enveloped anchor particle capable of attaching to the activated particle; and combining the enveloped anchor particle with the activated particle to form a removable complex in the potash tailings fluid. In embodiments, the method further comprises removing the removable complex from the potash tailings fluid. In embodiments, the method further comprises providing a tether capable of attachment to the enveloped anchor particle; and attaching the tether to the enveloped anchor particle.

Disclosed herein, in embodiments, are systems for removing particulate matter from a fluid, comprising an activating material capable of being affixed to the particulate matter to form an activated particle, an anchor particle capable of attaching to the activated particle to form a removable complex in the potash tailings fluid, and a separator for separating the removable complex from the potash tailings fluid, thereby removing the particulate matter. As disclosed herein, in embodiments, the fluid can be a potash tailings fluid, which can be derived from a tailings impoundment area. In embodiments, the anchor particle is a tether-bearing anchor particle. In embodiments, the anchor particle is an enveloped anchor particle.

### BRIEF DESCRIPTION OF FIGURES

The FIGURE is a schematic showing the activator polymer, tether polymer and anchor particle (ATA) system comprising three basic components: an activator polymer, a tether polymer and an anchor particle; the ATA system is contacted with the liquid fine tailing slurry resulting in self-assembly of the solid material and the expulsion of water.

### DETAILED DESCRIPTION

Disclosed herein are systems and methods for removing finely dispersed materials or “fines” from wastewater streams produced during mining operations. In embodiments, the clay fines produced during potash production can be removed with these systems and methods. As shown in the FIGURE, in some embodiments, the systems and methods comprise an activator polymer, a tether polymer and an anchor particle, termed “the ATA system.” This ATA system, when contacted with the liquid fine tailing slurry, for example in potash mining, results in self-assembly of the solid material suspended in the tailings slurry and the expulsion of water.

In certain embodiments, these systems and methods employ three subprocesses: (1) the “activation” of the wastewater stream bearing the fines by exposing it to a dose of a flocculating polymer that attaches to the fines; (2) the preparation of “anchor particles,” by treating fine particles, such as sand or salt (for example, NaCl, MgSO₄, MgCl₂, or CaSO₄), with a “tether” polymer that attaches to the anchor particles; and (3) adding the tether-bearing anchor particles to the activated wastewater stream containing the fines, so that the tether-bearing anchor particles form complexes with the activated fines. The activator polymer and the tether polymer have been selected so that they have a natural affinity with each other. Combining the activated fines with the tether-bearing anchor particles rapidly forms a solid complex that can be separated from the suspension fluid with a separator, resulting in a stable mass that can be easily and safely stored, along with clarified water that can be used for other industrial purposes. As used herein, the term “separator” refers to any mechanism, device, or method that separates the solid complex from the suspension fluid, i.e., that separates the removable complexes of tether-bearing anchor particle and activated particles from the fluid. Following the separation process, the stable mass can be used for beneficial purposes, as can the clarified water. As an example, the clarified water could be recycled for use on-site in further processing and beneficiation of ores. As an example, the stable mass could be used for construction purposes at the mine operation (roads, walls, etc.), or could be used as a construction or landfill material offsite. Dewatering to separate the solids from the suspension fluid can take place in seconds, relying only on gravity filtration.

Disclosed herein are systems and methods for enhancing the settlement rate of dispersed fine materials by incorporating them within a coarser particulate matrix, so that solids can be removed from aqueous suspension as a material having mechanical stability. The systems and methods disclosed herein involve three components: activating the fine particles, tethering them to anchor particles, and sedimenting the fine particle-anchor particle complex.

Generally speaking, the fines in the wastewater stream are “activated” by exposure to a dosing of flocculating polymer. Separately, the sand particles or other “anchor” particles are exposed to a polymer “tether.” The activator and tether are chosen so they have a natural affinity towards each other. Combining the two streams, the activated fines with tether-bearing anchors, produces a stable solid that forms rapidly. The solid can be separated from the clarified water in which it resides by a dewatering process, for example by gravity filtration, which can quickly yield a mass that can be easily and safely stored.

1. Activation

As used herein, the term “activation” refers to the interaction of an activating material, such as a polymer, with suspended particles in a liquid medium, such as an aqueous solution. In embodiments, high molecular weight polymers can be introduced into the particulate dispersion, so that these polymers interact, or complex, with fine particles. The polymer-particle complexes interact with other similar complexes, or with other particles, and form agglomerates.

This “activation” step can function as a pretreatment to prepare the surface of the fine particles for further interactions in the subsequent phases of the disclosed system and methods. For example, the activation step can prepare the surface of the fine particles to interact with other polymers that have been rationally designed to interact therewith in an optional, subsequent “tethering” step, as described below. Not to be bound by theory, it is believed that when the fine particles are coated by an activating material such as a polymer, these coated materials can adopt some of the surface properties of the polymer or other coating. This altered surface character in itself can be advantageous for sedimentation, consolidation and/or dewatering. In another embodiment, activation can be accomplished by chemical modification of the particles. For example, oxidants or bases/alkalis can increase the negative surface energy of particulates, and acids can decrease the negative surface energy or even induce a positive surface energy on suspended particulates. In another embodiment, electrochemical oxidation or reduction processes can be used to affect the surface charge on the particles. These chemical modifications can produce activated particulates that have a higher affinity for tethered anchor particles as described below.

Particles suitable for modification, or activation, can include organic or inorganic particles, or mixtures thereof. Inorganic particles can include one or more materials such as calcium carbonate, dolomite, calcium sulfate, kaolin, talc, titanium dioxide, sand, diatomaceous earth, aluminum hydroxide, silica, other metal oxides and the like. Sand or other fine fractions of the solids, such as sand recovered from the mining process itself, is preferred. Organic particles can include one or more materials such as starch, modified starch, polymeric spheres (both solid and hollow), and the like. Particle sizes can range from a few nanometers to few hundred microns. In certain embodiments, macroscopic particles in the millimeter range may be suitable.

In embodiments, a particle, such as an amine-modified particle, may comprise materials such as lignocellulosic material, cellulosic material, vitreous material, cementitious material, carbonaceous material, plastics, elastomeric materials, and the like. In embodiments, cellulosic and lignocellulosic materials may include wood materials such as wood flakes, wood fibers, wood waste material, wood powder, lignins, or fibers from woody plants.

Examples of inorganic particles include clays such as attapulgite and bentonite. In embodiments, the inorganic compounds can be vitreous materials, such as ceramic particles, glass, fly ash and the like. The particles may be solid or may be partially or completely hollow. For example, glass or ceramic microspheres may be used as particles. Vitreous materials such as glass or ceramic may also be formed as fibers to be used as particles. Cementitious materials may include gypsum, Portland cement, blast furnace cement, alumina cement, silica cement, and the like. Carbonaceous materials may include carbon black, graphite, carbon fibers, carbon microparticles, and carbon nanoparticles, for example carbon nanotubes.

In embodiments, the particle can be substantially larger than the fine particulates it is separating out from the process stream. For example, for the removal of particulate matter with approximate diameters less than 50 microns, particles may be selected for modification having larger dimensions. In other embodiments, the particle can be substantially smaller than the particulate matter it is separating out of the process stream, with a number of such particles interacting in order to complex with the much larger particulate matter. Particles may also be selected for modification that have shapes adapted for easier settling when compared to the target particulate matter: spherical particles, for example, may advantageously be used to remove flake-type particulate matter. In other embodiments, dense particles may be selected for modification, so that they settle rapidly when complexed with the fine particulate matter in the process stream. In yet other embodiments, extremely buoyant particles may be selected for modification, so that they rise to the fluid surface after complexing with the fine particulate matter, allowing the complexes to be removed via a skimming process rather than a settling-out process. In embodiments where the modified particles are used to form a filter, as in a filter cake, the particles selected for modification can be chosen for their low packing density or porosity. Advantageously, particles can be selected that are indigenous to a particular geographical region where the particulate removal process would take place.

In embodiments, plastic materials may be used as particles. Both thermoset and thermoplastic resins may be used to form plastic particles. Plastic particles may be shaped as solid bodies, hollow bodies or fibers, or any other suitable shape. Plastic particles can be formed from a variety of polymers. A polymer useful as a plastic particle may be a homopolymer or a copolymer. Copolymers can include block copolymers, graft copolymers, and interpolymers. In embodiments, suitable plastics may include, for example, addition polymers (e.g., polymers of ethylenically unsaturated monomers), polyesters, polyurethanes, aramid resins, acetal resins, formaldehyde resins, and the like. Addition polymers can include, for example, polyolefins, polystyrene, and vinyl polymers. Polyolefins can include, in embodiments, polymers prepared from C₂-C₁₀ olefin monomers, e.g., ethylene, propylene, butylene, dicyclopentadiene, and the like. In embodiments, poly(vinyl chloride) polymers, acrylonitrile polymers, and the like can be used. In embodiments, useful polymers for the formation of particles may be formed by condensation reaction of a polyhydric compound (e.g., an alkylene glycol, a polyether alcohol, or the like) with one or more polycarboxylic acids. Polyethylene terephthalate is an example of a suitable polyester resin. Polyurethane resins can include polyether polyurethanes and polyester polyurethanes. Plastics may also be obtained for these uses from waste plastic, such as post-consumer waste including plastic bags, containers, bottles made of high density polyethylene, polyethylene grocery store bags, and the like.

In embodiments, plastic particles can be formed as expandable polymeric pellets. Such pellets may have any geometry useful for the specific application, whether spherical, cylindrical, ovoid, or irregular. Expandable pellets may be pre-expanded before using them. Pre-expansion can take place by heating the pellets to a temperature above their softening point until they deform and foam to produce a loose composition having a specific density and bulk. After pre-expansion, the particles may be molded into a particular shape and size. For example, they may be heated with steam to cause them to fuse together into a lightweight cellular material with a size and shape conforming to the mold cavity. Expanded pellets may be 2 to 4 times larger than unexpanded pellets. As examples, expandable polymeric pellets may be formed from polystyrenes and polyolefins. Expandable pellets are available in a variety of unexpanded particle sizes. Pellet sizes, measured along the pellet's longest axis, on a weight average basis, can range from about 0.1 to 6 mm.

In embodiments, the expandable pellets may be formed by polymerizing the pellet material in an aqueous suspension in the presence of one or more expanding agents, or by adding the expanding agent to an aqueous suspension of finely subdivided particles of the material. An expanding agent, also called a “blowing agent,” is a gas or liquid that does not dissolve the expandable polymer and which boils below the softening point of the polymer. Blowing agents can include lower alkanes and halogenated lower alkanes, e.g., propane, butane, pentane, cyclopentane, hexane, cyclohexane, dichlorodifluoromethane, and trifluorochloromethane, and the like. Depending on the amount of blowing agent used and the technique for expansion, a range of expansion capabilities exist for any specific unexpanded pellet system. The expansion capability relates to how much a pellet can expand when heated to its expansion temperature. In embodiments, elastomeric materials can be used as particles. Particles of natural or synthetic rubber can be used, for example.

In embodiments, the particle can be substantially larger than the fine particulates it is separating out from the process stream. For example, for the removal of particulate matter with approximate diameters less than 50 microns, particles may be selected for modification having larger dimensions. In other embodiments, the particle can be substantially smaller than the particulate matter it is separating out of the process stream, with a number of such particles interacting in order to complex with the much larger particulate matter. Particles may also be selected for modification that have shapes adapted for easier settling when compared to the target particulate matter: spherical particles, for example, may advantageously be used to remove flake-type particulate matter. In other embodiments, dense particles may be selected for modification, so that they settle rapidly when complexed with the fine particulate matter in the process stream. In yet other embodiments, extremely buoyant particles may be selected for modification, so that they rise to the fluid surface after complexing with the fine particulate matter, allowing the complexes to be removed via a skimming process rather than a settling-out process. In embodiments where the modified particles are used to form a filter, as in a filter cake, the particles selected for modification can be chosen for their low packing density or porosity. Advantageously, particles can be selected that are indigenous to a particular geographical region where the particulate removal process would take place.

It is envisioned that the complexes formed from the modified particles and the particulate matter can be recovered and used for other applications. For example, when sand is used as the modified particle and it captures fine clay in tailings, the sand/clay combination can be used for road construction in the vicinity of the mining sites, due to the less compactable nature of the complexes compared to other locally available materials.

The “activation” step may be performed using flocculants or other polymeric substances. Preferably, the polymers or flocculants can be charged, including anionic or cationic polymers. In embodiments, anionic polymers can be used, including, for example, olefinic polymers, such as polymers made from polyacrylate, polymethacrylate, partially hydrolyzed polyacrylamide, and salts, esters and copolymers thereof “(such as sodium acrylate/acrylamide copolymers, polyacrylic acid, polymethacrylic acid, sulfonated polymers, such as sulfonated polystyrene, and salts, esters and copolymers thereof, and the like). Suitable polycations include: polyvinylamines, polyallylamines, polydiallyldimethylammoniums (e.g., polydiallyldimethylammonium chloride, branched or linear polyethyleneimine, crosslinked amines (including epichlorohydrin/dimethylamine, and epichlorohydrin/alkylenediamines), quaternary ammonium substituted polymers, such as (acrylamide/dimethylaminoethylacrylate methyl chloride quat) copolymers and trimethylammoniummethylene-substituted polystyrene, polyvinylamine, and the like. Nonionic polymers suitable for hydrogen bonding interactions can include polyethylene oxide, polypropylene oxide, polyhydroxyethylacrylate, polyhydroxyethylmethacrylate, and the like. In embodiments, an activator such as polyethylene oxide can be used as an activator with a cationic tethering material in accordance with the description of tethering materials below. In embodiments, activator polymers with hydrophobic modifications can be used. Flocculants such as those sold under the trademark MAGNAFLOC® by Ciba Specialty Chemicals can be used.

In embodiments, activators such as polymers or copolymers containing carboxylate, sulfonate, phosphonate, or hydroxamate groups can be used. These groups can be incorporated in the polymer as manufactured; alternatively they can be produced by neutralization of the corresponding acid groups, or generated by hydrolysis of a precursor such as an ester, amide, anhydride, or nitrile group. The neutralization or hydrolysis step could be done on site prior to the point of use, or it could occur in situ in the process stream.

The activated particle can also be an amine functionalized or modified particle. As used herein, the term “modified particle” can include any particle that has been modified by the attachment of one or more amine functional groups as described herein. The functional group on the surface of the particle can be from modification using a multifunctional coupling agent or a polymer. The multifunctional coupling agent can be an amino silane coupling agent as an example. These molecules can bond to a particle surface (e.g., metal oxide surface) and then present their amine group for interaction with the particulate matter. In the case of a polymer, the polymer on the surface of the particles can be covalently bound to the surface or interact with the surface of the particle and/or fiber using any number of other forces such as electrostatic, hydrophobic, or hydrogen bonding interactions. In the case that the polymer is covalently bound to the surface, a multifunctional coupling agent can be used such as a silane coupling agent. Suitable coupling agents include isocyano silanes and epoxy silanes as examples. A polyamine can then react with an isocyano silane or epoxy silane for example. Polyamines include polyallyl amine, polyvinyl amine, chitosan, and polyethylenimine.

In embodiments, polyamines (polymers containing primary, secondary, tertiary, and/or quaternary amines) can also self-assemble onto the surface of the particles or fibers to functionalize them without the need of a coupling agent. For example, polyamines can self-assemble onto the surface of the particles through electrostatic interactions. They can also be precipitated onto the surface in the case of chitosan for example. Since chitosan is soluble in acidic aqueous conditions, it can be precipitated onto the surface of particles by suspending the particles in a chitosan solution and then raising the solution pH.

In embodiments, the amines or a majority of amines are charged. Some polyamines, such as quaternary amines are fully charged regardless of the pH. Other amines can be charged or uncharged depending on the environment. The polyamines can be charged after addition onto the particles by treating them with an acid solution to protonate the amines. In embodiments, the acid solution can be non-aqueous to prevent the polyamine from going back into solution in the case where it is not covalently attached to the particle.

The polymers and particles can complex via forming one or more ionic bonds, covalent bonds, hydrogen bonding and combinations thereof, for example. Ionic complexing is preferred.

To obtain activated fine materials, the activator could be introduced into a liquid medium through several different means. For example, a large mixing tank could be used to mix an activating material with tailings from mining operations that contain fine particulate materials. Alternatively, the activating material can be added along a transport pipeline and mixed, for example, by a static mixer or series of baffles. Activated particles are produced that can be treated with one or more subsequent steps of tethering and anchor-separation.

The particles that can be activated are generally fine particles that are resistant to sedimentation. Examples of particles that can be filtered in accordance with the invention include metals, sand, inorganic, or organic particles. The particles are generally fine particles, such as particles having a mass mean diameter of less than 50 microns or particle fraction that remains with the filtrate following a filtration with, for example, a 325 mesh filter. The particles to be removed in the processes described herein are also referred to as “fines.”

2. Tethering

As used herein, the term “tethering” refers to an interaction between an activated fine particle and an anchor particle (as described below). The anchor particle can be treated or coated with a tethering material. The tethering material, such as a polymer, forms a complex or coating on the surface of the anchor particles such that the tethered anchor particles have an affinity for the activated fines. In embodiments, the selection of tether and activator materials is intended to make the two solids streams complementary so that the activated fine particles become tethered, linked or otherwise attached to the anchor particle. When attached to activated fine particles via tethering, the anchor particles enhance the rate and completeness of sedimentation or removal of the fine particles from the fluid stream.

In accordance with these systems and methods, the tethering material acts as a complexing agent to affix the activated particles to an anchor material. In embodiments, sand can be used as an anchor material, as may a number of other substances, as set forth in more detail below. In embodiments, a tethering material can be any type of material that interacts strongly with the activating material and that is connectable to an anchor particle.

As used herein, the term “anchor particle” refers to a particle that facilitates the separation of fine particles. Generally, anchor particles have a density that is greater than the liquid process stream. For example, anchor particles that have a density of greater than 1.3 g/cc can be used. Additionally or alternatively, the density of the anchor particles can be greater than the density of the fine particles or activated particles. Alternatively, the density is less than the dispersal medium, or density of the liquid or aqueous stream. Alternatively, the anchor particles are simply larger than the fine particles being removed. In embodiments, the anchor particles are chosen so that, after complexing with the fine particulate matter, the resulting complexes can be removed via a skimming process rather than a settling-out process, or they can be readily filtered out or otherwise skimmed off. In embodiments, the anchor particles can be chosen for their low packing density or potential for developing porosity. A difference in density or particle size can facilitate separating the solids from the medium.

For example, for the removal of particulate matter with an approximate mass mean diameter less than 50 microns, anchor particles may be selected having larger dimensions, e.g., a mass mean diameter of greater than 70 microns. An anchor particle for a given system can have a shape adapted for easier settling when compared to the target particulate matter: spherical particles, for example, may advantageously be used as anchor particles to remove particles with a flake or needle morphology. In other embodiments, increasing the density of the anchor particles may lead to more rapid settlement. Alternatively, less dense anchors may provide a means to float the fine particles, using a process to skim the surface for removal. In this embodiment, one may choose anchor particles having a density of less than about 0.9 g/cc, for example, 0.5 g/cc, to remove fine particles from an aqueous process stream.

Suitable anchor particles can be formed from organic or inorganic materials, or any mixture thereof. Particles suitable for use as anchor particles can include organic or inorganic particles, or mixtures thereof. In referring to an anchor particle, it is understood that such a particle can be made from a single substance or can be made from a composite. For example, coal can be used as an anchor particle in combination with another organic or inorganic anchor particle, or sodium chloride particles can be used as an anchor particle in combination with another organic or inorganic anchor particle. Any combination of inorganic or organic anchor particles can be used. Anchor particle combinations can be introduced as mixtures of heterogeneous materials. Anchor particles can be prepared as agglomerations of heterogeneous materials, or other physical combinations thereof. For example, an anchor particle can be formed from a particle of one type of biomass combined with a particle of another type of biomass. For example, an anchor particle can be formed from a combustible organic particle complexed, coated or otherwise admixed with other organic or inorganic anchor particle materials. As an example, a combustible organic material can be combined with particles of ungelatinized starch. In embodiments, the starch can be gelatinized during a thermal drying step, optionally with the use of an alkali, to cause binding and strengthening of the composite fuel product.

In accordance with these systems and methods, inorganic anchor particles can include one or more materials such as sodium chloride, calcium carbonate, dolomite, magnesium sulfate, magnesium chloride, calcium sulfate, kaolin, talc, titanium dioxide, sand, diatomaceous earth, aluminum hydroxide, silica, other metal oxides, and the like. In embodiments, the coarse fraction of the solids recovered from the mining process itself can be used for anchor particles, for example, coal from coal mining. In embodiments, a particulate waste material from a mining process can be used as an anchor particle, for example sodium chloride particles that are discarded as waste from potash mining. Organic particles can include one or more materials such as biomass, starch, modified starch, polymeric spheres (both solid and hollow), and the like. Particle sizes can range from a few nanometers to few hundred microns. In certain embodiments, macroscopic particles in the millimeter range may be suitable.

In embodiments, a particle, such as an amine-modified particle, can comprise materials such as lignocellulosic material, cellulosic material, minerals, vitreous material, cementitious material, carbonaceous material, plastics, elastomeric materials, and the like. In embodiments, cellulosic and lignocellulosic materials may include wood materials such as wood flakes, wood fibers, wood waste material, wood powder, lignins, or fibers from woody plants. Organic materials can include various forms of organic waste, including biomass and including particulate matter from post-consumer waste items such as old tires and carpeting materials.

Examples of inorganic particles include clays such as attapulgite and bentonite. In embodiments, the inorganic compounds can be vitreous materials, such as ceramic particles, glass, fly ash and the like. The particles may be solid or may be partially or completely hollow. For example, glass or ceramic microspheres may be used as particles. Vitreous materials such as glass or ceramic may also be formed as fibers to be used as particles. Cementitious materials may include gypsum, Portland cement, blast furnace cement, alumina cement, silica cement, and the like. Carbonaceous materials may include carbon black, graphite, carbon fibers, carbon microparticles, and carbon nanoparticles, for example carbon nanotubes.

Other inorganic materials available on-site (sand, salts such as sodium chloride, etc.) can be used as anchor particles, either alone or in combination with other inorganic or organic anchor particles. This technology has the advantage of using materials that are readily available on-site during mining or processing to treat the fines being produced there.

In embodiments, plastic materials may be used as particles. Both thermoset and thermoplastic resins may be used to form plastic particles. Plastic particles may be shaped as solid bodies, hollow bodies or fibers, or any other suitable shape. Plastic particles can be formed from a variety of polymers. A polymer useful as a plastic particle may be a homopolymer or a copolymer. Copolymers can include block copolymers, graft copolymers, and interpolymers. In embodiments, suitable plastics may include, for example, addition polymers (e.g., polymers of ethylenically unsaturated monomers), polyesters, polyurethanes, aramid resins, acetal resins, formaldehyde resins, and the like. Addition polymers can include, for example, polyolefins, polystyrene, and vinyl polymers. Polyolefins can include, in embodiments, polymers prepared from C₂-C₁₀ olefin monomers, e.g., ethylene, propylene, butylene, dicyclopentadiene, and the like. In embodiments, poly(vinyl chloride) polymers, acrylonitrile polymers, and the like can be used. In embodiments, useful polymers for the formation of particles may be formed by condensation reaction of a polyhydric compound (e.g., an alkylene glycol, a polyether alcohol, or the like) with one or more polycarboxylic acids. Polyethylene terephthalate is an example of a suitable polyester resin. Polyurethane resins can include polyether polyurethanes and polyester polyurethanes. Plastics may also be obtained for these uses from waste plastic, such as post-consumer waste including plastic bags, containers, bottles made of high density polyethylene, polyethylene grocery store bags, and the like. In embodiments, elastomeric materials can be used as particles. Particles of natural or synthetic rubber can be used, for example.

Advantageously, anchor particles can be selected from biomass, so that they complex with the fines to form a biomass-fines composite solid. This process can be advantageous in producing a combustible complex, for example by complexing coal fines with a biomass tether. Biomass can be derived from vegetable sources or animal sources. Biomass can be derived from waste materials, including post-consumer waste, animal or vegetable waste, agricultural waste, sewage, and the like. In embodiments, the biomass sourced materials are to be processed so that they form particles of an appropriate size for tethering and combining with the activated fines. Particle sizes of, e.g., 0.01-50 millimeters are desirable. Processing methods can include grinding, milling, pumping, shearing, and the like. For example, hammer mills, ball mills, and rod mills can be used to reduce oversized materials to an appropriate size. In embodiments, additives might be used in the processing of the anchor particles to improve efficiency, reduce energy requirements, or increase yield. These processing additives include polymers, surfactants, and chemicals that enhance digestion or disintegration. Optionally, other treatment modalities, such as exposure to cryogenic liquids (e.g., liquid nitrogen or solid carbon dioxide) can be employed to facilitate forming anchor particles of appropriate size from biomass. It is understood that biomass-derived anchor particles can be formed as particles of any morphology (regular or irregular, plate-shaped, flakes, cylindrical, spherical, needle-like, etc.) or can be formed as fibers. Fibrous materials may be advantageous in that they facilitate dewatering/filtration of the composite material being formed by these systems and methods, and they can add strength to such composite materials.

Vegetable sources of biomass can include fibrous material, particulate material, amorphous material, or any other material of vegetable origin. Vegetable sources can be predominately cellulosic, e.g., derived from cotton, jute, flax, hemp, sisal, ramie, and the like. Vegetable sources can be derived from seeds or seed cases, such as cotton or kapok, or from nuts or nutshells, including without limitation, peanut shells, walnut shells, coconut shells, and the like. Vegetable sources can include the waste materials from agriculture, such as corn stalks, stalks from grain, hay, straw, or sugar cane (e.g., bagasse). Vegetable sources can include leaves, such as sisal, agave, deciduous leaves from trees, shrubs and the like, leaves or needles from coniferous plants, and leaves from grasses. Vegetable sources can include fibers derived from the skin or bast surrounding the stem of a plant, such as flax, jute, kenaf, hemp, ramie, rattan, soybean husks, corn husks, rice hulls, vines or banana plants. Vegetable sources can include fruits of plants or seeds, such as coconuts, peach pits, olive pits, mango seeds, corncobs or corncob byproducts (“bees wings”) and the like. Vegetable sources can include the stalks or stems of a plant, such as wheat, rice, barley, bamboo, and grasses. Vegetable sources can include wood, wood processing products such as sawdust, and wood, and wood byproducts such as lignin.

Animal sources of biomass can include materials from any part of a vertebrate or invertebrate animal, fish, bird, or insect. Such materials typically comprise proteins, e.g., animal fur, animal hair, animal hoofs, and the like. Animal sources can include any part of the animal's body, as might be produced as a waste product from animal husbandry, farming, meat production, fish production or the like, e.g., catgut, sinew, hoofs, cartilaginous products, etc. Animal sources can include the dried saliva or other excretions of insects or their cocoons, e.g., silk obtained from silkworm cocoons or spider's silk. Animal sources can include dairy byproducts such as whey, whey permeate solids, milk solids, and the like. Animal sources can be derived from feathers of birds or scales of fish.

In embodiments, the anchor particle can be substantially larger than the fine particulates it is separating out from the process stream. For example, for the removal of fines with approximate diameters less than 50 microns, anchor particles may be selected for modification having larger dimensions. In other embodiments, the particle can be substantially smaller than the particulate matter it is separating out of the process stream, with a number of such particles interacting in order to complex with the much larger particulate matter. Particles may also be selected for modification that have shapes adapted for easier settling when compared to the target particulate matter: spherical particles, for example, may advantageously be used to remove flake-type particulate matter. In other embodiments, dense particles may be selected for modification, so that they settle rapidly when complexed with the fine particulate matter in the process stream. In yet other embodiments, extremely buoyant particles may be selected for modification, so that they rise to the fluid surface after complexing with the fine particulate matter, allowing the complexes to be removed via a skimming process rather than a settling-out process. In embodiments where the modified particles are used to form a filter, as in a filter cake, the particles selected for modification can be chosen for their low packing density or porosity. Advantageously, particles can be selected that are indigenous to a particular geographical region where the particulate removal process would take place. For example, sand can be used as the particle to be modified for removing particulate matter from the waste stream (tailings) in potash mining or other mining activities.

It is envisioned that the complexes formed from the modified particles and the particulate matter can be recovered and used for other applications. For example, when sand is used as the modified particle and it captures fine clay in tailings, the sand/clay combination can be used for road construction in the vicinity of the mining sites, due to the less compactable nature of the complexes compared to other locally available materials.

Anchor particle sizes (as measured as a mean diameter) can have a size up to few hundred microns, preferably greater than about 70 microns. In certain embodiments, macroscopic anchor particles up to and greater than about 1 mm may be suitable. Recycled materials or waste, particularly recycled materials and waste having a mechanical strength and durability suitable to produce a product useful in building roads and the like, or (in other embodiments) capable of combustion, are particularly advantageous.

As an example of a tethering material used with an anchor particle in accordance with these systems and methods, chitosan can be precipitated onto sand particles, for example, via pH-switching behavior. The chitosan can have affinity for anionic systems that have been used to activate fine particles. Anchor particles can be complexed with tethering agents, such agents being selected so that they interact with the polymers used to activate the fines. In one example, partially hydrolyzed polyacrylamide polymers can be used to activate particles, resulting in a particle with anionic charge properties. The cationic charge of the chitosan will attract the anionic charge of the activated particles, to attach the sand particles to the activated fine particles.

In embodiments, various interactions such as electrostatic, hydrogen bonding or hydrophobic behavior can be used to affix an activated particle or particle complex to a tethering material complexed with an anchor particle.

In embodiments, the anchor particles can be combined with a polycationic polymer, for example a polyamine. One or more populations of anchor particles may be used, each being activated with a tethering agent selected for its attraction to the activated fines and/or to the other anchor particle's tether. The tethering functional group on the surface of the anchor particle can be from modification using a multifunctional coupling agent or a polymer. The multifunctional coupling agent can be an amino silane coupling agent as an example. These molecules can bond to an anchor particle's surface and then present their amine group for interaction with the activated fines. In the case of a tethering polymer, the polymer on the surface of the particles can be covalently bound to the surface or interact with the surface of the anchor particle and/or fiber using any number of other forces such as electrostatic, hydrophobic, or hydrogen bonding interactions. In the case that the polymer is covalently bound to the surface, a multifunctional coupling agent can be used such as a silane coupling agent. Suitable coupling agents include isocyano silanes and epoxy silanes as examples. A polyamine can then react with an isocyano silane or epoxy silane for example. Polyamines include polyallyl amine, polyvinyl amine, chitosan, and polyethylenimine.

In embodiments, polyamines (polymers containing primary, secondary, tertiary, and/or quaternary amines) can also self-assemble onto the surface of the particles or fibers to functionalize them without the need of a coupling agent. For example, polyamines can self-assemble onto the surface of the particles through electrostatic interactions. They can also be precipitated onto the surface in the case of chitosan for example. Since chitosan is soluble in acidic aqueous conditions, it can be precipitated onto the surface of particles by suspending the particles in a chitosan solution and then raising the solution pH.

In embodiments, the amines or a majority of amines are charged. Some polyamines, such as quaternary amines are fully charged regardless of the pH. Other amines can be charged or uncharged depending on the environment. The polyamines can be charged after addition onto the particles by treating them with an acid solution to protonate the amines. In embodiments, the acid solution can be non-aqueous to prevent the polyamine from going back into solution in the case where it is not covalently attached to the particle.

The polymers and particles can complex via forming one or more ionic bonds, covalent bonds, hydrogen bonding and combinations thereof, for example. Ionic complexing is preferred.

As an example of a tethering material used with an anchor particle in accordance with these systems and methods, chitosan can be precipitated onto anchor particles, for example, via pH-switching behavior. The chitosan as a tether can have affinity for anionic systems that have been used to activate fine particles. In one example, partially hydrolyzed polyacrylamide polymers can be used to activate the fines, resulting in a particle with anionic charge properties. The cationic charge of the chitosan will attract the anionic charge of the activated particles, to attach the anchor particles to the activated fines. In the foregoing example, electrostatic interactions can govern the assembly of the activated fine particle complexes bearing the anionic partially-hydrolyzed polyacrylamide polymer and the cationic anchor particles complexed with the chitosan tethering material.

In embodiments, polymers such as linear or branched polyethyleneimine can be used as tethering materials. It would be understood that other anionic or cationic polymers could be used as tethering agents, for example polydiallyldimethylammonium chloride poly(DADMAC). In other embodiments, cationic tethering agents such as epichlorohydrin dimethylamine (epi/DMA), styrene maleic anhydride imide (SMAI), polyethylene imide (PEI), polyvinylamine, polyallylamine, amine-aldehyde condensates, poly(dimethylaminoethyl acrylate methyl chloride quaternary) polymers and the like can be used. Advantageously, cationic polymers useful as tethering agents can include quaternary ammonium or phosphonium groups. Advantageously, polymers with quaternary ammonium groups such as poly(DADMAC) or epi/DMA can be used as tethering agents. In other embodiments, polyvalent metal salts (e.g., calcium, magnesium, aluminum, iron salts, and the like) can be used as tethering agents. In other embodiments cationic surfactants such as dimethyldialkyl(C₈-C₂₂)ammonium halides, alkyl(C₈-C₂₂)trimethylammonium halides, alkyl(C₈-C₂₂)dimethylbenzylammonium halides, cetyl pyridinium chloride, fatty amines, protonated or quaternized fatty amines, fatty amides and alkyl phosphonium compounds can be used as tethering agents. In embodiments, polymers having hydrophobic modifications can be used as tethering agents.

The efficacy of a tethering material, however, can depend on the activating material. A high affinity between the tethering material and the activating material can lead to a strong and/or rapid interaction there between. A suitable choice for tether material is one that can remain bound to the anchor surface, but can impart surface properties that are beneficial to a strong complex formation with the activator polymer. For example, a polyanionic activator can be matched with a polycationic tether material or a polycationic activator can be matched with a polyanionic tether material. In one embodiment, a poly(sodium acrylate-co-acrylamide) activator is matched with a chitosan tether material.

In hydrogen bonding terms, a hydrogen bond donor should be used in conjunction with a hydrogen bond acceptor. In embodiments, the tether material can be complementary to the chosen activator, and both materials can possess a strong affinity to their respective deposition surfaces while retaining this surface property.

The activator may be a cationic or an anionic material, as long as it has an affinity for the fine particles to which it attaches. The complementary tethering material can be selected to have affinity for the specific anchor particles being used in the system. In other embodiments, hydrophobic interactions can be employed in the activation-tethering system.

Suitable anchor particles can be formed from organic or inorganic materials, or any mixture thereof. Anchor particle sizes (as measured as a mass mean diameter) can have a size up to few hundred microns, preferably greater than about 70 microns. In certain embodiments, macroscopic anchor particles up to and greater than about 1 mm may be suitable. Recycled materials or waste, particularly recycled materials and waste having a mechanical strength and durability suitable to produce a product useful in building roads and the like are particularly advantageous.

As an example of a tethering material used with an anchor particle in accordance with these systems and methods, chitosan can be precipitated onto sand particles, for example, via pH-switching behavior. The chitosan can have affinity for anionic systems that have been used to activate fine particles. In one example, partially hydrolyzed polyacrylamide polymers can be used to activate particles, resulting in a particle with anionic charge properties. The cationic charge of the chitosans will attract the anionic charge of the activated particles, to attach the sand particles to the activated fine particles.

In embodiments, various interactions such as electrostatic, hydrogen bonding or hydrophobic behavior can be used to affix an activated particle or particle complex to a tethering material complexed with an anchor particle. In the foregoing example, electrostatic interactions can govern the assembly of the activated fine particle complexes bearing the anionic partially-hydrolyzed polyacrylamide polymer and the cationic sand particles complexed with the chitosan tethering material.

In embodiments, polymers such as linear or branched polyethyleneimine can be used as tethering materials. It would be understood that other anionic or cationic polymers could be used as tethering agents, for example polydiallyldimethylammonium chloride. The efficacy of a tethering material, however, can depend on the activating material. A high affinity between the tethering material and the activating material can lead to a strong and/or rapid interaction therebetween.

A suitable choice for tether material is one that can remain bound to the anchor surface, but can impart surface properties that are beneficial to a strong complex formation with the activator polymer. For example, a polyanionic activator can be matched with a polycationic tether material or a polycationic activator can be matched with a polyanionic tether material. In hydrogen bonding terms, a hydrogen bond donor should be used in conjunction with a hydrogen bond acceptor. In embodiments, the tether material can be complimentary to the chosen activator, and both materials can possess a strong affinity to their respective deposition surfaces while retaining this surface property.

In embodiments, activator polymers useful for potash tailing activation can be cationic polymers, for example cationic acrylamides. A cationic activator can be paired with an anionic tether, as is described above. In other embodiments, however, the activator polymer can be anionic, for example an anionic polymer selected from the anionic polymers described above as tether polymers. If an anionic polymer is used as an activator, a cationic polymer can be used as a tether. Such a tethering polymer would be selected from the cationic polymers described above as activator polymers.

In other embodiments, cationic-anionic interactions can be arranged between activated fine particles and tether-bearing anchor particles. The activator may be a cationic or an anionic material, as long as it has an affinity for the fine particles to which it attaches. The complementary tethering material can be selected to have affinity for the specific anchor particles being used in the system. In other embodiments, hydrophobic interactions can be employed in the activation-tethering system.

The anchor particle material is preferably added in an amount that permits a flowable slurry. For example, the particle material can be added in an amount greater than 1 gram/liter but less than the amount which results in a non-flowable sludge, amounts between about 1 to about 10 grams/liter, preferably 2 to 6 g/l are often suitable. In some embodiments, it may be desirable to maintain the concentration of the anchor particles to 20 g/l or higher. The anchor particles may be fresh (unused) material, recycled, cleaned ballast, or recycled, uncleaned ballast.

In embodiments, for example when sand is chosen as an anchor particle, higher amounts of the particle material may be added. For example, sand can be added in a range between 1-300 gm/l, preferably between 50-300 gm/l, for example at a dosage level of 240 gm/l.

3. Enveloping the Anchor Particles

In certain embodiments, the anchor particles can be modified by enveloping them with an additional agent in conjunction with or instead of attaching tethering agents thereto, thereby producing additional desirable properties. For example, waxes such as beeswax, Carnauba wax, Paraffin wax, Castor wax, and tallows, for example, can be used to partially or completely envelop the anchor particles, before or simultaneous with the application of the tethering agents thereto. The wax or other enveloping agent can be directed to form a discrete layer on the anchor particles, using techniques such as dry blending, melting, or mixing with a compatible solvent. The anchor particles thus modified (i.e., completely or partially enveloped) can then be used for particular purposes. As an example, a modifier such as wax on an anchor particle can enhance brine recovery. An anchor particle without the enveloping agent may have an affinity for the brine so that it decreases the amount of brine that is recoverable. In embodiments, certain enveloping agents as disclosed herein can form barriers that prevent the sequestration of brine by the anchor particles themselves. As other examples, hydrocarbons and hydrocarbon blends such as castor oil, vegetable oil, mineral oil, fuel oil, kerosene, and the like, can be used as enveloping agents, producing anchor particle solids that more readily release brine for reuse in a potash processing plant. The anchor particles that have been enveloped by enveloping agents can be used in lieu of or in combination with tethering agents.

4. Removal of the Removable Complexes

It is envisioned that the complexes formed from the anchor particles and the activated particulate matter can be recovered and used for other applications. For example, when sand is used as the modified particle and it captures fine clay in tailings, the dewatered sand/clay combination can be used for road construction in the vicinity of the mining sites, due to the less compactable nature of the complexes compared to other locally available materials. As another example, a sand/clay complex could be used to fill in strip mining pits, such as would be found at mining operations facilities. In other embodiments, complexes with anchor particles and fines could be used in a similar manner on-site to fill in abandoned mines, or the complexes could be used off-site for landfill or construction purposes. The uses of the solid material produced by the systems and methods disclosed herein will vary depending on the specific constituents of the material.

In embodiments, the interactions between the activated fine particles and the tether-bearing anchor particles can enhance the mechanical properties of the complex that they form. For example, an activated fine particle or collection thereof can be durably bound to one or more tether-bearing anchor particles, so that they do not segregate or move from the position that they take on the particles. This property of the complex can make it mechanically more stable.

Increased compatibility of the activated fine materials with a denser (anchor) matrix modified with the appropriate tether polymer can lead to further mechanical stability of the resulting composite material. This becomes quite important when dealing with tailings resulting from mining. This composite material can then be further utilized within the project for road building, dyke construction, or even land reclamation, rather than simply left in a pond to settle at a much slower rate.

A variety of techniques are available for removing the activated-tethered-anchored (ATA) complexes or removable complexes from the fluid stream. For example, the tether-bearing anchor particles can be mixed into a stream carrying activated fine particles, and the complexes can then be separated via a settling process such as gravity or centrifugation. In another method, the process stream carrying the activated fine particles could flow through a bed or filter cake of the tether-bearing anchor particles. In any of these methods, the modified particles interact with the fine particulates and pull them out of suspension so that later separation removes both modified particles and fine particulates.

As would be appreciated by artisans of ordinary skill, a variety of separation processes could be used to remove the complexes of modified particles and fine particulates. In the aforesaid removal processes, mechanical interventions for separating the removable complexes can be introduced, employing various devices as separators (filters, skimmers, centrifuges, and the like). Or other separation techniques can be employed. For example, if the anchor particles had magnetic properties, the complexes formed by the interaction of tether-bearing anchor particles and activated fine particulates could be separated using a magnetic field. As another example, if the tether-bearing anchor particles were prepared so that they were electrically conductive, the complexes formed by the interaction of tether-bearing anchor particles and activated fine particulates could be separated using an electric field. As would be further appreciated by those of ordinary skill, tether-bearing anchor particles could be designed to complex with a specific type of activated particulate matter. The systems and methods disclosed herein could be used for complexing with organic waste particles, for example. Other activation-tethering-anchoring systems may be envisioned for removal of suspended particulate matter in fluid streams, including gaseous streams.

5. Exemplary Applications

a. Tailings Processing

Extraction of minerals from ores can produce fine, positively charged particles of clay or other materials that remain suspended in the effluent fluid stream. The effluent fluid stream can be directed to a mechanical separator such as a cyclone that can separate the fluid stream into two components, an overflow fluid comprising fine tails that contains the fine (<approximately 50 micron) particles, and an underflow fluid stream that contains coarse tails, mainly sand, with a small amount of fine clay particles.

In embodiments, the systems and methods disclosed herein can treat each fluid stream, an overflow fluid and/or an underflow fluid. An activating agent, such as a polyanion as described above, can preferably be introduced into the overflow fluid stream, resulting in a flocculation of the fine particles therein, often forming a soft, spongy mass. The underflow fluid can be used for the preparation of tether-bearing anchor particles. However, it will be clear that other sources for anchor particles (e.g., sand) can also be used. In certain tailings fluids, the sand within the underflow fluid itself can act as an “anchor particle,” as described above. A cationic tethering agent, as described above, can be introduced into the underflow fluid so that it self-assembles onto the surface of the anchor particles, creating a plurality of tether-bearing anchor particles.

Following this treatment to each fluid stream, the two fluid streams can be re-mixed in a batch, semi-batch or continuous fashion. The tether-bearing anchor particles can interact, preferably electrostatically, with the activated, preferably flocculating, fine particles, forming large agglomerations of solid material that can be readily removed from or settled in the resulting fluid mixture.

In embodiments, the aforesaid systems and methods are amenable to incorporation within existing tailings separation systems. For example, a treatment process can be added in-line to each of the separate flows from the overflow and underflow fluids; treated fluids then re-converge to form a single fluid path from which the resulting agglomerations can be removed. Removal of the agglomerations can take place, for example, by filtration, centrifugation, or other type of mechanical separation.

In one embodiment, the fluid path containing the agglomerated solids can be subsequently treated by a conveyor belt system, analogous to those systems used in the papermaking industry. In an exemplary conveyor belt system, the mixture of fluids and agglomerated solids resulting from the electrostatic interactions described above can enter the system via a headbox. A moving belt containing a mechanical separator can move through the headbox, or the contents of the headbox are dispensed onto the moving belt, so that the wet agglomerates are dispersed along the moving belt. One type of mechanical separator can be a filter with a pore size smaller than the average size of the agglomerated particles. The size of the agglomerated particles can vary, depending upon the size of the constituent anchor particles (i.e., sand). For example, for systems where the sand component has a size between 50/70 mesh, an 80 mesh filter can be used. Other adaptations can be envisioned by artisans having ordinary skill in the art. Agglomerated particles can be transported on the moving belt and further dewatered. Water removed from the agglomerated particles and residual water from the headbox from which agglomerates have been removed can be collected in whole or in part within the system and optionally recycled for use in subsequent processing.

In embodiments, the filtration mechanism can be an integral part of the moving belt. In such embodiments, the captured agglomerates can be physically removed from the moving belt so that the filter can be cleaned and regenerated for further activity. In other embodiments, the filtration mechanism can be removable from the moving belt. In such embodiments, the spent filter can be removed from the belt and a new filter can be applied. In such embodiments, the spent filter can optionally serve as a container for the agglomerated particles that have been removed.

Advantageously, as the agglomerated particles are arrayed along the moving belt, they can be dewatered and/or dried. These processes can be performed, for example, using heat, air currents, or vacuums. Agglomerates that have been dewatered and dried can be formed as solid masses, suitable for landfill, construction purposes, or the like.

Desirably, the in-line tailings processing described above is optimized to capitalize upon the robustness and efficiency of the electrostatic interaction between the activated tailings and the tether-bearing anchor particles. Advantageously, the water is quickly removed from the fresh tailings during the in-line tailings processing, permitting its convenient recycling into the processing systems.

b. Remediation of Treatment Ponds

The systems and methods disclosed herein can be used for treatment of tailings at a facility remote from the mining and beneficiation facility or in a pond. Similar principles are involved: the fluid stream bearing the fine tailings can be treated with an anionic activating agent, preferably initiating flocculation. A tether-bearing anchor particle system can then be introduced into the activated tailings stream, or the activated tailings stream can be introduced into a tether-bearing anchor particle system. In embodiments, a tailings stream containing fines can be treated with an activating agent, as described above, and applied to a stationary or moving bed of tether-bearing anchor particles. For example, a stationary bed of tether-bearing anchor particles can be arranged as a flat bed over which the activated tailings stream is poured. The tether-bearing anchor particles can be within a container or housing, so that they can act as a filter to trap the activated tailings passing through it. On a larger scale, the tether-bearing anchor particles can be disposed on a large surface, such as a flat or inclined surface (e.g., a beach), so that the activated tailings can flow over and through it, e.g. directionally toward a pond.

As an example, sand particles retrieved from the underflow fluid stream can be used as the anchor particles to which a cationic tether is attached. A mass of these tether-bearing anchor particles can be arranged to create a surface of a desired thickness, forming an “artificial beach” to which or across which the activated tailings can be applied. As would be appreciated by those of ordinary skill in the art, the application of the activated tailings to the tether-bearing anchor particles can be performed by spraying, pouring, pumping, layering, flowing, or otherwise bringing the fluid bearing the activated tailings into contact with the tether-bearing anchor particles. The activated tailings are then associated with the tether-bearing anchor particles while the remainder of the fluid flows across the surface and into a collection pond or container.

In embodiments, an adaptation of the activator-tether-anchor systems disclosed herein can be applied to the remediation of existing tailings ponds for mining operations. Tailings ponds can comprise different layers of materials, reflecting the gravity-induced settlement of fresh tailings after long residence periods in the pond. For example, the top layer in the tailings pond can comprise clarified water. The next layer is a fluid suspension of fine particles like fine tailings. The fluid becomes denser and denser, often settling into a stable suspension of fluid fine tailings that has undergone self-weight consolidation/dewatering, where the suspended particles have not yet settled out. The bottom layer is formed predominately from material that has settled by gravity. Desirably, the strata of the tailings pond containing suspended particles can be treated to separate the water that they contain from the fine particles suspended therein. The resultant clarified water can be drawn off and the solid material can be reclaimed. This could reduce the overall size of the tailings ponds, or prevent them from growing larger as fresh untreated tailings are added.

In embodiments, the systems and methods disclosed herein can be adapted to treat tailings ponds. In an embodiment, an activating agent, for example, one of the anionic polymers disclosed herein can be added to a pond, or to a particle-bearing layer within a tailings pond, such as by injection with optional stirring or agitation. Tether-bearing anchor particles can then be added to the pond or layer containing the activated fine particles. For example, the tether-bearing anchor particles can be added to the pond from above, so that they descend through the activated layer. As the activated layer is exposed to the tether-bearing anchor particles, the flocculated fines can adhere to the anchor particles and be pulled down to the bottom of the pond by gravity, leaving behind clarified water. The tailings pond can thus be separated into two components, a top layer of clarified water, and a bottom layer of congealed solid material. The top layer of clarified water can then be recycled for use, for example in further ore processing. The bottom layer of solids can be retrieved, dewatered and used for construction purposes, landfill, and the like.

c. Treating Waste or Process Streams

Particles modified in accordance with these systems and methods may be added to fluid streams to complex with the particulate matter suspended therein so that the complex can be removed from the fluid. In embodiments, the modified particles and the particulate matter may interact through electrostatic, hydrophobic, covalent or any other type of interaction whereby the modified particles and the particulate matter form complexes that are able to be separated from the fluid stream. The modified particles can be introduced to the process or waste stream using a variety of techniques so that they complex with the particulate matter to form a removable complex. A variety of techniques are also available for removing the complexes from the fluid stream. For example, the modified particles can be mixed into the stream and then separated via a settling process such as gravity or centrifugation. If buoyant or low-density modified particles are used, they can be mixed with the stream and then separated by skimming them off the surface. In another method, the process stream could flow through a bed or filter cake of the modified particles. In any of these methods, the modified particles interact with the fine particulates and pull them out of suspension so that later separation removes both modified particles and fine particulates.

The particles described herein can be utilized to sequester and suspend fines and pollutants from waste tailings. The technology can be used for the treatment of waste slurry as it is generated or can be used for the remediation of existing tailings ponds. As discussed below, massive amounts of waste tailings are generated in the course of energy production and other mining endeavors. Such wastes or waste fluids can include, but are not limited to, oilfield drilling waste, fine coal tailings and coal combustion residues. Mining endeavors producing wastes and waste fluids include, but are not limited to, processing and beneficiation of ores such as bauxite, phosphate, taconite, kaolin, trona, potash and the like. Mining endeavors having a waste slurry stream of fine particulate matter, can also include without limitation the following mining processes: sand and gravel, nepheline syenite, feldspar, ball clay, kaolin, olivine, dolomite, calcium carbonate containing minerals, bentonite clay, magnetite and other iron ores, barite, and talc.

As an example, potash mining operations result in wastewater handling issues that can be advantageously addressed with the systems and methods disclosed herein. Potash is the general name for potassium salts, including potassium carbonate, and is mined for agricultural (fertilizer) use. A large portion of the mined potash ore ends up as a waste, either as a solid or slurry, called potash tailings. The potash tailings slurry is an aqueous saturated salt/brine stream that contains waste ore, clays, and other fine materials. The most common method for disposal is to pump the potash tailings into above-ground impoundment areas or mined underground pits. The large volumes of tailings and high salinity pose significant disposal issues. Additionally, large amounts of salt simply end up in these waste streams. Environmental concerns are adding increased pressure for potash mining companies to find alternatives to tailings ponds as a disposal practice.

A number of other mining operations produce fine particulate waste carried in fluid streams. Such fluid streams are suitable for treatment by the systems and methods disclosed herein. Modification of the fluid stream before, during or after application of these systems and methods may be advantageous. For example, pH of the fluid stream can be adjusted. Examples of additional mineral mining operations that have a waste slurry stream of fine particulate matter can include the following mining processes: sand and gravel, nepheline syenite, feldspar, ball clay, kaolin, olivine, dolomite, calcium carbonate containing minerals, bentonite clay, magnetite and other iron ores, barite, and talc.

### Examples

### Examples 1 to 7

The following materials were used in the Examples 1-7 below:
Washed Sea Sand, 50+70 Mesh, Sigma Aldrich, St. Louis, Mo.
Chitosan CG 800, Primex, Siglufjodur, Iceland
Branched Polyethyleneimine (BPEI) (50% w/v), Sigma Aldrich, St. Louis, Mo.
Polyvinyl Amine—Lupamin 1595, Lupamin 9095, BASF, Ludwigshafen, Germany
Poly(diallyldimethylammonium chloride) (pDAC) (20% w/v), Sigma Aldrich, St. Louis, Mo.
FD&C Blue #1, Sigma Aldrich, St. Louis, Mo.
Hydrochloric Acid, Sigma Aldrich, St. Louis, Mo.
Tailings Solution from a low-grade tar sand
Dicalite, Diatomaceous Earth, Grefco Minerals, Inc., Burney, Calif.
3-Isocyanatopropyltriethoxysilane, Gelest, Morrisville, Pa.
Sodium Hydroxide, Sigma Aldrich, St. Louis, Mo.
Isopropyl Alcohol (IPA), Sigma Aldrich, St. Louis, Mo.

### Example 1

### BPEI Coated Diatomaceous Earth

Diatomaceous earth (DE) particles coupled with BPEI are created using a silane coupling agent. 100 g of DE along with 1000 mL isopropyl alcohol (IPA) and a magnetic stir bar is placed into an Erlenmeyer flask. 1 gm 3-Isocyanatopropyltriethoxysilane is added to this solution and allowed to react for 2 hours. After 2 hours, 2 mL of BPEI is added and stirred for an additional 5 hours before filtering and washing the particles with IPA 2x's and deionized water (DI water). The particles are then filtered and washed with a 0.12 M HCl solution in isopropanol (IPA) then dried.

### Example 2

### 1% Chitosan CG800 Stock Solution

The chitosan stock solution is created by dispersing 10 g of chitosan (flakes) in 1000 mL of deionized water. To this solution is added hydrochloric acid until a final pH of 5 is achieved by slowly and incrementally adding 12 M HCl while continuously monitoring the pH. This solution becomes a stock solution for chitosan deposition.

### Example 3

### Diatomaceous Earth—1% Chitosan Coating

10 g of diatomaceous earth is added to 100 mL deionized water with a stir bar to create a 10% slurry. To this slurry is added 10 mL's of the 1% chitosan stock solution of CG800. The slurry is allowed to stir for 1 hour. Once the slurry becomes homogeneous the polymer is precipitated out of solution by the slow addition of 0.1 N sodium hydroxide until the pH stabilizes above 7 and the chitosan precipitates onto the particles of diatomaceous earth. The slurry is filtered and washed with a 0.05 M HCl solution in isopropanol (IPA) then dried.

### Example 4

### Particle Performance on Tailings Solution

Coated and uncoated diatomaceous earth particles were used in experiments to test their ability to settle dispersed clay fines in an aqueous solution. The following procedure was used for each type of particle, and a control experiment was also performed where the particle addition step was omitted.

One gram of particles was added to a centrifugation tube. Using a syringe, the centrifugation tube was then filled with 45 ml of tailing solution containing dispersed clay. One more tube was filled with just the tailings solution and no diatomaceous earth particles. The tube was manually shaken for 30 seconds and than placed on a flat countertop. The tube was then observed for ten minutes allowing the clay fines to settle out.

Results:

No DE addition (control samples): Tailing solution showed no significant improvement in cloudiness.

DE Coated with Chitosan: Tailing solution was significantly less cloudy compared to control samples.

DE Coated with BPEI: Tailing solution was significantly less cloudy compared to control samples.

DE Uncoated: Tailing solution showed no significant improvement in cloudiness compared to control samples.

### Example 5

### Preparation of Polycation-Coated Washed Sea Sand

Washed sea sand is coated with each of the following polycations: chitosan, lupamin, BPEI, and PDAC. To perform the coating, an aqueous solution was made of the candidate polycation at 0.01M concentration, based on its molecular weight. 50 g washed sea sand was then placed in a 250 ml jar, to which was added 100 ml of the candidate polycation solution. The jar was then sealed and rolled for three hours. After this, the sand was isolated from the solution via vacuum filtration, and the sand was washed to remove excess polymer. The coated sea sand was then measured for cation content by solution depletion of an anionic dye (FD&C Blue #1) which confirmed deposition and cationic nature of the polymeric coating. The sea sand coated with the candidate polymer was then used as a tether-attached anchor particle in interaction with fine particulate matter that was activated by treating it with an activating agent.

### Example 6

### Use of Polymer-Coated Sea Sand to Remove Fine Particles from Solution

In this Example, a 45 ml. dispersion of fine materials (7% solids) from an oil sands tailings stream is treated with an activating polymer (MAGNAFLOC® LT30, 70 ppm). The fines were mixed thoroughly with the activating polymer. 10 gm of sea sand that had been coated with PDAC according to the methods of Example 1 were added to the solution containing the activated fines. This mixture is agitated and is immediately poured through a stainless steel filter, size 70 mesh. After a brief period of dewatering, a mechanically stable solid is retrieved. The filtrate is also analyzed for total solids, and is found to have a total solids content of less than 1%.

### Example 7

### Use of Sea Sand without Polymer Coating to Remove Fine Particles from Solution (Control)

In this Example, a 45 ml. dispersion of fine materials (7% solids) is treated with an activating polymer (MAGNAFLOC® LT30, 70 ppm). The fines were mixed thoroughly with the activating polymer. 10 gm of uncoated sea sand were added to the solution containing the activated fines. This mixture is agitated and is immediately poured through a stainless steel filter, size 70 mesh. The filtrate is analyzed for total solids, and is found to have a total solids content of 2.6%.

### Example 8

### Polymer Screening for Potash Tailings

Solutions of the polymers shown in Table 1 were prepared and kept at room temperature. All solutions were prepared at 0.1 wt % concentration using deionized water, except for polystyrene sulfonate (PSS), which was made into a solution at a concentration of 1 wt % using deionized water. These polymer solutions were screened for use with tailings provided by a potash mine. Polymer solutions were screened for use as activator polymers or as tether particles to be attached to anchor particles, as described in more detail below. When a polymer was used as a tether polymer, it was used in combination with a separate activator polymer. For anchor particles to be used with tether polymers, washed sea sand from Sigma-Aldrich was used (50+70 mesh, as was used in Examples 5-7 above). In experiments using anchor particles with tethers, the ratio of anchor particles to clay content in the tailings is 1.0.

TABLE 1
Polymers screened for treatment of potash tailings

| | | | | Molecular |
|---|---|---|---|---|
| | | | Charge | Weight |
| Polymer | Manufacturer | Charge | Density | (g/mol) |
| MAGNAFLOC ® | Ciba | Non- | 0% | High |
| 333 | Corporation | ionic | | |
| Polyethylene | Sigma-Aldrich | Non- | 0% | 8,000,000 |
| Oxide | | ionic | | |
| MAGNAFLOC ® | Ciba | Anionic | 10% | High |
| 10 | Corporation | | | |
| MAGNAFLOC ® | Ciba | Anionic | 30% | High |
| 336 | Corporation | | | |
| MAGNAFLOC ® | Ciba | Anionic | 50% | High |
| LT30 | Corporation | | | |
| Polystyrene | Sigma-Aldrich | Anionic | 100% | 1,000,000 |
| Sulfonate | | | | |
| SMA 1000i | Sartomer | Cationic | Low | Low |
| HYPERFLOC ® | Hychem, Inc | Cationic | Low | 5,000,000 |
| CP 905 | | | | |
| LUPASOL ® P | BASF | Cationic | 20 meq/g | 750,000 |
| PDAC | Sigma-Aldrich | Cationic | 100% | 400,000- |
| | | | | 500,000 |

### Example 9

### Potash Tailings Samples

Tailings samples from an operating potash mine were used to assess the efficacy of various polymeric solutions as activator polymers or tether polymers. The composition of the tailings samples was approximately:
15 wt % clay,
15 wt % salt,
22 wt % brine, and
48 wt % water.

Polymers were tested for efficacy in tailings treatment as (1) an activator polymer; (2) a tether polymer in an activated stream without anchor particles, or (3) a tether polymer for anchor particles in an activated stream.

For those tailings samples treated with an activator only, the activator polymer was added to an aliquot of tailings sample at room temperature to form a 500 ppm solution of activator in tailings sample. The samples were inverted six times and allowed to sit for three minutes. Samples of the supernatant were removed with a pipet to determine turbidity values, and the remaining sample was poured onto an 80-mesh screen, where the retained solids were analyzed for their solids content. For those tailings samples treated with a tether polymer in an activated stream without anchor particles, the tether polymer was added to an already activated stream and then inverted six times. For those tailings samples treated with tether-bearing anchor particles in an activated stream, tether-bearing anchor particles were prepared by adding the tether polymer to the anchor particles and gently shaking by hand for approximately 10 seconds. An activator polymer selected to pre-treat the tailings sample was added to the tailings sample to form a 500 ppm solution, following which the solution was inverted six times. Then the tether-bearing anchor particles were added to the activated solution, followed by six inversions. After three minutes, the turbidity of the supernatant was measured, and then the solids were analyzed for solids content after gravity filtration on an 80-mesh screen.

The following tailings samples were treated with the test polymers.
Diluted tailings with deionized (DI) water
Diluted tailings with supernatant water
Undiluted Tailings

Before each treatment, the tailings sample was agitated with an overhead mixer to resuspend salt and clay suspensions that settled during shipment from the mine. After each treatment, the treated solution was allowed to settle for three minutes before taking turbidity values of the supernatant water with a turbidimeter. Afterwards, the solution was filtered using a wire mesh, and solids content values of solids filtered were measured using a moisture balance.

### Example 10

### Diluted Tailings with Deionized (DI) Water

The tailings solution described in Example 9 was diluted to 50% with DI water. Test polymers were used as (1) activator polymers, (2) as tether polymers in an activated stream, and (3) as tether polymers attached to anchor particles, in an activated stream. The concentration of polymer used as activator and as tether for each test was 500 ppm. For each test, the turbidity and the solids content of the solutions were measured. The results with various test polymers is set forth in Table 2.

TABLE 2
Screening of PEO, Lupasol P, SMA and MF
336 using tailings diluted with DI water

| | | | Tur- | Solids |
|---|---|---|---|---|
| | | Anchor | bidity | Content |
| Activator | Tether | Particle | (NTU) | (%) |
| PEO | — | — | >1000 | — |
| PEO | MF 336 | — | 238 | 44.1 |
| PEO | MF 336 | SIGMA- | 156 | 63.9 |
| | | ALDRICH ® | | |
| | | Sand | | |
| LUPASOL ® P | — | — | >1000 | — |
| LUPASOL ® P | MF 336 | — | 345 | 45.8 |
| LUPASOL ® P | MF 336 | SIGMA- | 133 | 55.7 |
| | | ALDRICH ® | | |
| | | Sand | | |
| SMA | — | — | >1000 | — |
| SMA | MF 336 | — | 527 | 46.4 |
| SMA | MF 336 | SIGMA- | 216 | 58.4 |
| | | ALDRICH ® | | |
| | | Sand | | |
| MF 336 | PEO | — | 245 | 42.0 |
| MF 336 | PEO | SIGMA- | 134 | 57.4 |
| | | ALDRICH ® | | |
| | | Sand | | |
| MF 336 | LUPASOL ® P | — | 97.2 | 43.3 |
| MF 336 | LUPASOL ® P | SIGMA- | 101 | 56.0 |
| | | ALDRICH ® | | |
| | | Sand | | |
| MF 336 | SMA | — | 610 | 42.6 |
| MF 336 | SMA | SIGMA- | 369 | 55.1 |
| | | ALDRICH ® | | |
| | | Sand | | |

When the diluted tailings were treated with with polyethylene oxide (PEO), Lupasol P, SMA, and MF 336 as Activators, no visible solid aggregates were produced. However, when each of these polymers was coupled with MF 336, significant aggregation of solid material was seen.

Better results were obtained when Hyperfloc was used to treat tailings diluted with DI water. Treatment with Hyperfloc, alone or in combination with MF 336, resulted in significantly lower turbidity values and slightly higher solids content values than treatments with other polymers in this study. The measurements from this round of testing are shown in Table 3. The polymers used in this screening were applied at 250 ppm or 500 ppm, as indicated in the Table.

TABLE 3
Screening of HYPERFLOC ® and MF 336
using tailings diluted with DI water

| | | | | Tur- | Solids |
|---|---|---|---|---|---|
| Dosage | | | Anchor | bidity | Content |
| (ppm) | Activator | Tether | Particle | (NTU) | (%) |
| 250 | HYPER- | — | — | 59.5 | 44.4 |
| | FLOC ® | | | | |
| 250 | HYPER- | MF 336 | — | 11.9 | 42.3 |
| | FLOC ® | | | | |
| 250 | HYPER- | MF 336 | SIGMA- | 9.42 | 56.9 |
| | FLOC ® | | ALDRICH ® | | |
| | | | Sand | | |
| 250 | MF 336 | HYPER- | — | 9.94 | 46.8 |
| | | FLOC ® | | | |
| 250 | MF 336 | HYPER- | SIGMA- | 10.6 | 54.8 |
| | | FLOC ® | ALDRICH ® | | |
| | | | Sand | | |
| 500 | HYPER- | — | — | 109 | 43.9 |
| | FLOC ® | | | | |
| 500 | HYPER- | MF 336 | — | 25.3 | 46.2 |
| | FLOC ® | | | | |
| 500 | HYPER- | MF 336 | SIGMA- | 16.8 | 63.9 |
| | FLOC ® | | ALDRICH ® | | |
| | | | Sand | | |
| 500 | MF 336 | HYPER- | — | 12.1 | 44.4 |
| | | FLOC ® | | | |
| 500 | MF 336 | HYPER- | SIGMA- | 7.35 | 64.8 |
| | | FLOC ® | ALDRICH ® | | |
| | | | Sand | | |

Additional tests were carried out using potash tailings diluted with the supernatant from settled tailings, to show that the use of DI water did not affect the behavior of the polymers used in the previous tests. For these experiments, MF 336 was used as the activator and PDAC was used as the tether, both in dosages of 500 ppm. As shown in Table 4, there was no significant difference in turbidity values between the two test panels, indicating that the use of the DI water did not impact polymer performance.

TABLE 4
Comparison of turbidity values between screens
using DI water and supernatant water as diluents
with MF 336 as Activator and PDAC as Tether

Turbidity (NTU)

| | Dilution with | Dilution with |
|---|---|---|
| Treatment | DI water | supernatant water |
| Activator Only | 185 | 229 |
| Tether Only | >1000 | >1000 |
| Activator + Tether | 327 | 331 |
| Activator + Tether + Anchor | 218 | 233 |

### Example 11

### Undiluted Tailings

Using an undiluted tailings stream described in Example 9, test polymers were added as (1) activator polymers, (2) as tether polymers in an activated stream, and (3) as tether polymers attached to anchor particles, in an activated stream. Polymers were used in the doses set forth in Table 5. For each test, the turbidity and the solids content of the solutions were measured. The results with various test polymers are set forth in Table 5.

TABLE 5
Screening of Hyperfloc and MF 336 using undiluted tailings

| | | | | Tur- | Solids |
|---|---|---|---|---|---|
| Dosage | | | Anchor | bidity | Content |
| (ppm) | Activator | Tether | Particle | (NTU) | (%) |
| 250 | HYPER- | — | — | >1000 | — |
| | FLOC ® | | | | |
| 500 | HYPER- | — | — | >1000 | — |
| | FLOC ® | | | | |
| 1000 | HYPER- | — | — | 273* | — |
| | FLOC ® | | | | |
| 1000 | HYPER- | MF 336 | — | — | 55.0 |
| | FLOC ® | | | | |
| 1500 | HYPER- | — | — | 24.4⁺ | 57.4 |
| | FLOC ® | | | | |
| 1500 | HYPER- | MF 336 | — | 22.7⁺ | 52.4 |
| | FLOC ® | | | | |
| 1500 | HYPER- | MF 336 | SIGMA- | 26.2⁺ | 63.2 |
| | FLOC ® | | ALDRICH ® | | |
| | | | Sand | | |

*Turbidity value measured after 10 minutes of settling
⁺Turbidity values measured immediately after treatment

When used as activators, LT30, MF 336, and PSS produced no visible aggregates in the undiluted tailings. These same polymers, as well as MF 10 and MF 333, when used as Activators, also failed to produce visible aggregates with PDAC-Tethered sand Anchor particles. The turbidity values are over measurable range for all the screens. The use of HYPERFLOC® gave rise to visible aggregates when added to undiluted tailings at a dosage of 1500 ppm. The filtrates from the treated samples have much lower turbidity values than the untreated sample or even the supernatant from the untreated sample. The solids content values also increase after all treatments. This effect is most pronounced when the complete ATA process is used.

When the tailings are treated as described above using 1500 ppm HYPERFLOC® as activator polymer, MF 336 as tether and sand as anchor particle, solids separated from a clarified brine of low turbidity. Solids obtained after gravity filtration of the treated tailings through a mesh screen were stable, easily handled, and had mechanical integrity. During a 48 hour drying test of the solids so obtained, the solid mass maintains its shape with drying, and its mechanical integrity improved significantly. The dried solid showed no signs of disintegration, suggesting that it would be fit for disposal as a solid without forming dust. To further test the stability of the recovered solids from this process, a portion of the solids was immersed in tap water for over one week. The solid mass appeared intact in the tap water during this test period.

### Example 12

### Modified Anchor Particles for Tailings Treatments

The following materials were used for this Example:
Polymers for treatment of potash tailings (see Table 6).
   The polymers were dissolved in de-ionized water to make 0.3% solutions.

TABLE 6
Polymers tested for treatment of potash tailings

| | | | | Molecular |
|---|---|---|---|---|
| | | | Charge | Weight |
| Polymer | Manufacturer | Charge | Density | (g/mol) |
| HYPERFLOC CP | Hychem, Inc | Cationic | Low | 5,000,000 |
| 905HH | | | | |
| HYPERFLOC 10 | Ciba | Anionic | 10% | High |
| | Corporation | | | |
| HYPERFLOC 336 | Ciba | Anionic | 30% | High |
| | Corporation | | | |

Modifying agents for coarse particle treatment (see Table 7)

TABLE 7
Chemicals used to modify coarse particles

| Chemical | Manufacturer |
|---|---|
| Ethyl Alcohol | Sigma-Aldrich |
| Naphthenic Acid | Sigma-Aldrich |
| Paraffin Wax | Sigma-Aldrich |
| Prosoft TQ 2028 | GP Cellulose |
| Sodium Dodecyl Sulfate | Sigma-Aldrich |

Concentrated tailings, dry salt particles, and brine solution provided by an operating potash mine

Concentrated tailings as received:
Brine content=38.2%
Clay content=5.8%
Water content=56.0%

Brine as received: Solids content=35.1%

Dry salt particles, solids content 99.2%

Coarse salt particles were enveloped with enveloping agents as follows. For the paraffin wax enveloping agent, salt particles were enveloped with the paraffin wax at a preselected weight percentage as set forth in Table 8 to produce a uniform enveloping layer by mixing with a FLACKTEK SPEEDMIXER™ at 3000 rpm for 3 minutes. ProSoft TQ 2028 or Sodium Dodecyl Sulfate were added along with the enveloping agent at a preselected weight percentage as set forth in Table 8. The heat from the mixing procedure was high enough to melt the wax so that it formed the uniform layer on the salt particles. For the naphthenic acid enveloping layer, this acid was dissolved first in ethyl alcohol to form a 10% solution by weight. This solution was then added to the salt particles at a specified dosage as set forth in Table 8, and the mixture was shaken vigorously before air-drying at room temperature for two hours. After drying, the enveloped particles were used as anchor particles in the experiments below.

Tailings as received were prepared for testing as follows. Before each treatment, the concentrated tailings solution was agitated with an overhead mixer to resuspend salt and clay particles that had settled during shipment and storage. Next, a portion of the tailings were diluted to 2% clay content with the brine solution provided by the mine to correspond with plant conditions. The tailings thus prepared were then further treated as described below.

To initiate tailings treatment, an activator polymer (such as HYPERFLOC® CP 905HH, Hychem 303HH, or MAGNAFLOC® 336, set forth in Table 6) was added to the tailing prepared as in the preceding paragraph. The activator was added at the doses described in Table 8. Modified anchor particles were prepared to be combined with the activated tailings, as set forth in Table 8. As shown in Table 8, a set of modified anchor particles were prepared from the enveloped salt particles (either salt enveloped with paraffin wax or salt enveloped with naphthenic acid, as described above). Another set of modified anchor particles were prepared that combined salt enveloped with paraffin wax at varying amounts with the tethering agents Prosoft or SDS, all as set forth in Table 8. Activator dosage used was 500 ppm, with respect to clay fines content in the tailings. The coarse-to-fines ratio was 3:1.

After the activated tailings and the modified anchors are combined, as described in Example 9, the combined preparation was allowed to settle for three minutes so that solids separated from fluid. The turbidity of the fluid (water) supernate was tested with a turbidimeter. Then the preparation was filtered through an 80-mesh screen and the solids content values of recovered solids were measured using a moisture balance. The findings for these tests are set forth in Table 8.

TABLE 8
Turbidity and solids content values obtained after
ATA treatment using coated coarse salt particles

| Activator | Coarse Coating | Turbidity | Solids % |
|---|---|---|---|
| HYPERFLOC ® CP | 1% Naphthenic Acid in | 29.7 | 69.9 |
| 905HH | Ethanol | | |
| HYPERFLOC ® CP | 1% wax | 16.7 | 65.7 |
| 905HH | | | |
| HYPERFLOC ® CP | 1% wax + 1% Sodium | 55.2 | 66.9 |
| 905HH | Dodecyl Sulfate | | |
| MAGNAFLOC ® 10 | 1% wax + 1% Prosoft | 22.2 | 64.9 |
| | TQ 2028 | | |
| MAGNAFLOC ® 10 | 5% wax + 1% Prosoft | 22.8 | 67.8 |
| | TQ 2028 | | |
| MAGNAFLOC ® 10 | 3% wax + 3% Prosoft | 24.2 | 67.9 |
| | TQ 2028 | | |

### EQUIVALENTS

While specific embodiments of the subject invention have been discussed, the above specification is illustrative and not restrictive. Many variations of the invention will become apparent to those skilled in the art upon review of this specification. Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth herein are approximations that can vary depending upon the desired properties sought to be obtained by the present invention.

While this invention has been particularly shown and described with references to preferred embodiments thereof, it will be understood by those skilled in the art that various changes in form and details may be made therein without departing from the scope of the invention encompassed by the appended claims.

1. A method of removing particulate matter from potash tailings fluid, comprising:
providing an activating material capable of being affixed to the particulate matter;
affixing the activating material to the particulate matter to form an activated particle;
providing an anchor particle and providing a tethering material capable of being affixed to the anchor particle; and
attaching the tethering material to the anchor particle and the activated particle to form a removable complex in the potash tailings fluid, wherein the removable complex comprises the particulate matter.

2. The method of claim 1, further comprising removing the removable complex from the potash tailings fluid.

3. The method of claim 2, wherein the removable complex is removed by a method selected from the group consisting of filtration, centrifugation and gravitational settling.

4. The method of claim 1, wherein the anchor particle is enveloped by an enveloping agent.

5. The method of claim 4, wherein the enveloping agent is selected from the group consisting of waxes, hydrocarbons and hydrocarbon blends.

6. The method of claim 1, wherein the anchor particle comprises sand.

7. The method of claim 1, wherein the anchor particle comprises a salt particle.

8. The method of claim 1, wherein the anchor particle comprises a material indigenous to the mining operation.

9. The method of claim 1, wherein the particulate matter comprises clay fines.

10. The method of claim 1, further comprising chemically modifying the potash tailings fluid.

11. The product obtained or obtainable by the method of claim 1.

12. The method of claim 1, wherein the potash tailings fluid comprises waste tailing fluid from a mining operation.

13. The method of claim 1, wherein the potash tailings fluid comprises impounded tailings in a containment area.

14. A method of removing particulate matter from potash tailings fluid, comprising:
providing an activating material capable of being affixed to the particulate matter in the potash tailings fluid;
affixing the activating material to the particulate matter to form an activated particle;
providing an anchor particle and enveloping it with an enveloping agent to form an enveloped anchor particle capable of attaching to the activated particle; and
combining the enveloped anchor particle with the activated particle to form a removable complex in the potash tailings fluid.

15. The method of claim 14, further comprising removing the removable complex from the potash tailings fluid.

16. The method of claim 14, further comprising:
providing a tether capable of attachment to the enveloped anchor particle; and
attaching the tether to the enveloped anchor particle.

17. A system for removing particulate matter from a potash tailings fluid, comprising:
an activating material capable of being affixed to the particulate matter to form an activated particle,
an anchor particle capable of attaching to the activated particle to form a removable complex in the potash tailings fluid, and
a separator for separating the removable complex from the potash tailings fluid, thereby removing the particulate matter.

18. The system of claim 17, wherein the potash tailings fluid is derived from a tailings impoundment area.

19. The system of claim 17, wherein the anchor particle is a tether-bearing anchor particle.

20. The system of claim 17, wherein the anchor particle is an enveloped anchor particle.
